(19) United States
(12) Patent Application Publication
(10) Pub. No.: US 2024/0274847 A1
(43) Pub. Date: Aug. 15, 2024

(54) CARBON-OXYGEN BATTERY AND METHOD OF USE THEREOF

(71) Applicant: Form Energy, Inc., Somerville, MA (US)

(72) Inventors: William Henry Woodford, Somerville, MA (US); Tyler Grandahl, Carlisle, MA (US); Hwan Moon, Ellington, CT (US)

(21) Appl. No.: 18/631,919

(22) Filed: Apr. 10, 2024

Related U.S. Application Data
(63) Continuation-in-part of application No. 18/378,860, filed on Oct. 11, 2023.
(60) Provisional application No. 63/415,233, filed on Oct. 11, 2022.
(60) Provisional application No. 63/415,230, filed on Oct. 11, 2022.

(51) Int. Cl. H01M 8/0612; H01M 8/04007; H01M 8/04746; H01M 8/0668; H01M 8/12; H01M 8/1246; H01M 12/08

(52) U.S. Cl. CPC H01M 8/0631; H01M 8/04067; H01M 8/04753; H01M 8/0668; H01M 8/1246; H01M 12/08; H01M 2008/1293

(57) ABSTRACT

A carbon-oxygen battery system, including: a Boudouard reactor in fluid communication with an electrochemical cell, wherein the electrochemical cell has a CO/CO₂ inlet, a CO/CO₂ outlet, and an oxygen outlet, and wherein the CO/CO₂ outlet is fluidly connected by a first stream to an inlet of the Boudouard reactor, and wherein the CO/CO₂ inlet is fluidly connected by a second stream to an outlet of the Boudouard reactor, and a CO/CO₂ tank fluidly connected to at least one of the first stream or the second stream.

### CROSS REFERENCE TO RELATED APPLICATIONS

This application is a Continuation-In-Part of U.S. patent application Ser. No. 18/378,860, filed on Oct. 11, 2023, which claims priority to and the benefit of U.S. Provisional Patent Application No. 63/415,233, filed on Oct. 11, 2022, and U.S. Provisional Patent Application No. 63/415,230, filed on Oct. 11, 2022, the contents of each of which are hereby incorporated by reference in their entirety.

### BACKGROUND

This disclosure relates to a carbon-oxygen battery system, a method of use thereof, and a method of manufacturing the carbon-oxygen battery system.

Rechargeable batteries are electrochemical devices that can deliver electricity on discharge and can be charged to store electricity. Rechargeable batteries help solve the problem of discontinuous production of electrical energy and allow for storing electrical energy when the electricity supply does not match the electricity demand.

To achieve sufficient energy storage, multiple electrochemical cells are typically interconnected to provide a suitable output voltage and current capacity. For example, multiple electrochemical cells may be interconnected to form a stack of electrochemical cells, and the stacks may be further interconnected to provide the rechargeable battery. A problem often encountered in the failure of such rechargeable batteries is degradation or malfunction of one or more electrochemical cells within a stack, which often requires replacement of the entire stack. It can further be advantageous to accurately estimate the energy stored in such rechargeable batteries at a given time.

Carbon-oxygen rechargeable batteries are a promising technology for energy storage. Carbon-oxygen batteries leverage low-cost materials (e.g., carbon dioxide, carbon monoxide, carbon, and oxygen from ambient air) to reversibly store energy. There remains a continuing need for an improved carbon-oxygen battery system. It would be further advantageous to provide a carbon-oxygen battery system having field-replaceable components to allow for maintenance, repair, and servicing of the system while it is in the field. Field-repairable systems avoid added shipping and logistics costs. Furthermore, field-repairable systems allow for decoupled lifetime and reliability requirements of subsystems, which is advantageous to meet overall system-level lifetime and reliability requirements in the most cost-effective manner. It is further advantageous to provide field-repairable designs allowing for continuous use of the rechargeable battery functionality without requiring complete shutdown of the system and capable of providing accurate and rapid means to assess the quantity of stored energy.

### SUMMARY

Provided is a carbon-oxygen battery system, comprising: a Boudouard reactor in fluid communication with an electrochemical cell, wherein the electrochemical cell has a CO/CO₂ inlet, a CO/CO₂ outlet, and an oxygen outlet, and wherein the CO/CO₂ outlet is fluidly connected by a first stream to an inlet of the Boudouard reactor, and wherein the CO/CO₂ inlet is fluidly connected by a second stream to an outlet of the Boudouard reactor; and a CO/CO₂ tank fluidly connected to at least one of the first stream or the second stream.

Also provided is a method of operating the carbon-oxygen battery system, the method comprising: supplying electricity and a CO/CO₂ stream to the carbon-oxygen battery system to charge the battery system, wherein the CO/CO₂ stream is provided by the CO/CO₂ tank, carbon dioxide from the CO/CO₂ stream is converted to carbon monoxide and oxygen by the electrochemical cell, the carbon monoxide from the electrochemical cell is converted to carbon dioxide and carbon in a Boudouard reaction, and the carbon produced by the charging is stored in a carbon source; and discharging the battery system to convert the carbon to carbon dioxide and produce electricity, wherein the carbon and carbon dioxide are converted in a Boudouard reaction to carbon monoxide, the carbon monoxide and oxygen are converted to carbon dioxide by the electrochemical cell, the carbon dioxide is added to the CO/CO₂ stream, and the CO/CO₂ produced by the discharging is stored in the CO/CO₂ tank.

Also provided is a method of operating a carbon-oxygen battery system, the method comprising: providing a carbon-oxygen battery system comprising a Boudouard reactor in fluid communication with an electrochemical cell, wherein the electrochemical cell has a CO/CO₂ inlet, a CO/CO₂ outlet and an oxygen outlet, wherein the CO/CO₂ outlet is fluidly connected by a first stream to an inlet of the Boudouard reactor, and wherein the CO/CO₂ inlet is fluidly connected by a second stream to an outlet of the Boudouard reactor; and a CO/CO₂ tank fluidly connected to at least one of the first stream or the second stream; supplying electricity and a CO/CO₂ stream to the carbon-oxygen battery system to charge the battery system, wherein the CO/CO₂ stream is provided by the CO/CO₂ tank, carbon dioxide from the CO/CO₂ stream is converted to carbon monoxide and oxygen by the electrochemical cell, the carbon monoxide from the electrochemical cell is converted to carbon dioxide and carbon in a Boudouard reaction, and the carbon produced by the charging is stored in a carbon source; and discharging the battery system to convert the carbon to carbon dioxide and produce electricity, wherein the carbon and carbon dioxide are converted in a Boudouard reaction to carbon monoxide, the carbon monoxide and oxygen are converted to carbon dioxide by the electrochemical cell, the carbon dioxide is added to the CO/CO₂ stream, and the CO/CO₂ produced by the discharging is stored in the CO/CO₂ tank.

Also provided is a method of operating a carbon-oxygen battery system, the method comprising: providing the carbon-oxygen battery system; and installing a removable electrochemical cell to operate the system.

Also provided is a method of manufacturing the carbon-oxygen battery system, the method comprising: providing a Boudouard reactor in fluid communication with an electrochemical cell, wherein the electrochemical cell having a CO/CO₂ inlet, a CO/CO₂ outlet and an oxygen outlet, wherein the CO/CO₂ outlet is fluidly connected by a first stream to an inlet of the Boudouard reactor, and wherein the CO/CO₂ inlet is fluidly connected by a second stream to an outlet of the Boudouard reactor; and providing a CO/CO₂ tank fluidly connected to at least one of the first stream or the second stream to manufacture the carbon-oxygen battery system.

The above and other aspects and features are described and exemplified by the following figures and detailed description.

### BRIEF DESCRIPTION OF THE DRAWINGS

The following figures are exemplary embodiments wherein the like elements are numbered alike.

FIG. 1 illustrates a charge process of a carbon-oxygen battery system according to one or more aspects;

FIG. 2A illustrates the overall cell charge chemistry of a solid oxide cell for use in a carbon-oxygen-battery system according to one or more aspects;

FIG. 2B illustrates the overall cell charge chemistry of a molten carbonate cell for use in a carbon-oxygen-battery system according to one or more aspects;

FIG. 3 is a schematic diagram illustrating an electrochemical cell according to one or more aspects;

FIG. 4 is a schematic diagram illustrating a carbon-oxygen battery system according to one or more aspects;

FIG. 5 is a schematic diagram illustrating a carbon-oxygen battery system according to one or more aspects;

FIG. 6 is a schematic diagram illustrating a carbon-oxygen battery system according to one or more aspects;

FIG. 7 is a schematic diagram illustrating a carbon-oxygen battery system according to one or more aspects;

FIG. 8 is a schematic diagram illustrating a carbon-oxygen battery system according to one or more aspects; and

FIG. 9 is a schematic diagram illustrating a carbon-oxygen battery system according to one or more aspects.

### DETAILED DESCRIPTION

Carbon-oxygen battery systems include an electrochemical cell that converts CO₂ to CO and O₂ on charge, or CO and O₂ to CO₂ on discharge, and a Boudouard reactor that converts CO to CO₂ and C on charge, or provides CO from CO₂ and C on discharge. The net reaction is provided in reaction (1):

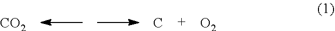

wherein the reaction proceeds to the right on charge and to the left on discharge. Due to their high energy density and high theoretical round-trip efficiency, carbon-oxygen battery systems are desirable for stationary storage applications.

In certain configurations, the net reaction (1) can be accomplished in two steps according to reactions (2) and reaction (3), where reaction (2) is the electrolysis of carbon dioxide occurring at the negative electrode of an electrochemical cell, and reaction (3) is a catalytic reaction, known as the Boudouard reaction, which leads to the formation of solid carbon:

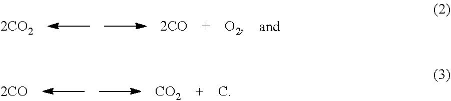

It is noted that the solid carbon may generally be in any form and can include, for example, particles, needles, plates, slabs, granules, rods, wires, filaments, and the like or a combination thereof. The carbon may be pure elemental carbon or may comprise impurities. The carbon may by crystalline or amorphous. The carbon may be graphitic.

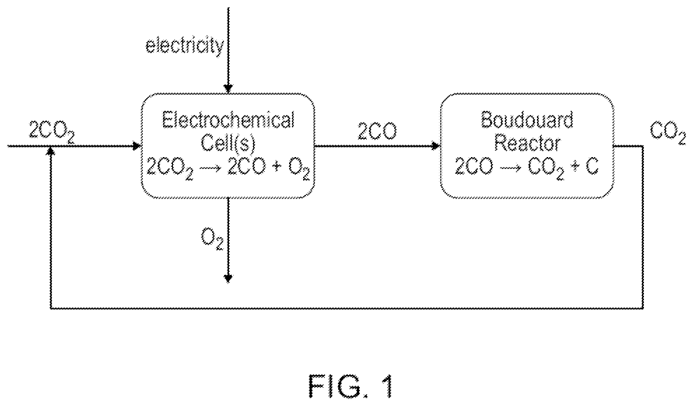

FIG. 1 illustrates the charging process for a carbon-oxygen battery system that includes an electrochemical cell and a Boudouard reactor. On charge, carbon dioxide electrolysis occurs in the electrochemical cell to provide carbon monoxide and oxygen. The oxygen may be captured or released, e.g., into the atmosphere, whereas the carbon monoxide is converted by the Boudouard reactor into carbon dioxide and elemental carbon. On discharge, the electrochemical cell uses oxygen (e.g., from ambient air or from a dedicated oxygen stream) and the elemental carbon and carbon dioxide are converted by the Boudouard reactor into carbon monoxide, where the carbon monoxide and oxygen are then converted into carbon dioxide by the electrochemical cell. Operating the carbon-oxygen battery in discharge mode produces electricity.

It is further noted that in reaction (2), the conversion of carbon dioxide into carbon monoxide and oxygen is endothermic and thus requires heat as an input, while in reaction (3), the conversion of carbon monoxide into solid carbon is exothermic. Thus reaction (2) uses heat and electricity as inputs, while reaction (3) generates heat as an output. Thus the two reaction steps may be coupled and allowed to proceed at a higher efficiency than if separate heat input (e.g., for reaction 2) and heat dissipation (e.g., for reaction 3) were required. Coupling of the reaction steps can be facilitated by, for example, incorporation of an appropriate heat exchanger, as discussed further in detail below. The heat produced by the Boudouard conversion reaction of carbon monoxide into solid carbon can be transferred and therefore contribute towards driving the reaction converting carbon dioxide into carbon monoxide. An optimal heat balance may also be achieved when the system is operated in discharge mode. In this case the heat necessary to drive the gasification of carbon particles (i.e., driving reaction (3) in the left-hand direction) into carbon monoxide may be provided by the exothermic electrochemical reaction of converting carbon monoxide into carbon dioxide (i.e., driving of reaction 2 in the left-hand direction).

In practice, an electrochemical cell may also fail prematurely. For example, the electrochemical cell may be provided within a thermal enclosure to facilitate operation at elevated temperatures to improve performance. However, exposure to elevated temperature may also result in degradation of the electrochemical cell. For example, high temperatures can accelerate solid state diffusion, which can promote microstructural coarsening of electrolyte, catalysts, or interconnection materials, as well as the interdiffusion of undesirable ions into cell components. For example, the poisoning of electrolytes by chromium (Cr) species used in interconnection materials is known in high temperature solid oxide cells. Other extreme conditions such as temperature swings, gas environments, mechanical loads, and so forth can also increase wear on the battery components. Timely replacement of parts or addition of materials enables the overall battery system to have a longer lifespan.

Disclosed herein is a carbon-oxygen battery system. In some aspects, the carbon-oxygen battery system may be configured to estimate the energy remaining in the battery system at a given time. For example, monitoring the energy remaining in the battery system can enable estimation of the remaining runtime if the battery is discharged, or the remaining energy which may be added into the system in a charging mode. Estimating the energy in the system is often referred to as “fuel gauging” in the art, and may also be known as “state of charge estimation,” “SOC estimation,” “state of energy estimation,” or “SOE estimation”. In some aspects of the present disclosure, the carbon-oxygen battery system can alternatively or additionally include field replaceable electrochemical cells. Field replaceable cells can accommodate component replacement in a fielded system without the need for additional installation/de-installation, shipping, and transport of an entire system. Method of use of the carbon-oxygen battery system, including estimating remaining energy and isolating and replacing battery components, e.g., an electrochemical cell, during continued operation of the battery system are also discussed herein.

Accordingly, an aspect of the present disclosure provides a carbon-oxygen battery system comprising a Boudouard reactor in fluid communication with an electrochemical cell. The electrochemical cell has a CO/CO₂ inlet, a CO/CO₂ outlet, and an oxygen outlet. The CO/CO₂ outlet is fluidly connected by a first stream to an inlet of the Boudouard reactor. The CO/CO₂ inlet is fluidly connected by a second stream to an outlet of the Boudouard reactor. The carbon-oxygen battery system further comprising a CO/CO₂ tank fluidly connected to at least one of the first stream or the second stream.

In an aspect, the Boudouard reactor can be configured to function as a carbon source. In an aspect, the carbon-oxygen battery system can further comprise a carbon source in fluid communication with the Boudouard reactor, wherein carbon source material can be fluidly supplied to the Boudouard reactor. In an aspect, the carbon-oxygen battery system can further comprise a carbon source and a conveyance member. The conveyance member can be configured to convey carbon source material between the Boudouard reactor and the carbon source. Representative conveyance members can include, for example, a belt conveyor, a screw feed, a vacuum conveyor, a gravitation feed, a pneumatic conveyor, or a vibrating conveyor. In certain aspects, the conveyance of carbon material between the Boudouard reactor and the carbon source may be accomplished by transport manually, through a vehicle, a robot, or through various combinations and permutations thereof.

In an aspect, the carbon source may be fluidically connected to the electrochemical cell via the first stream or the second stream. In a specific aspect, the carbon source can be fluidically connected to the first stream or the second stream between the Boudouard reactor and at least one of the CO/CO₂ inlet or the CO/CO₂ outlet of the electrochemical cell. In another specific aspect, the carbon source can be fluidically connected to the second stream between the CO/CO₂ outlet of the electrochemical cell and the Boudouard reactor. In an aspect, the carbon source can be fluidically connected to the second stream between the CO/CO₂ tank and the Boudouard reactor.

In an aspect, the system can further comprise a fuel gauge. As discussed above, fuel gauging can provide a measure or an estimate of the energy remaining in the system. For example, in an aspect, the fuel gauge can be configured to sense the carbon source. The fuel gauge can be a sensor configured to determine a mass of carbon in the carbon source, a volume of carbon in the carbon source, or a combination thereof (also referred to herein as a “carbon sensor”). In certain aspects, the mass sensor can be a scale or a load cell. In certain aspects, the volume of material in the carbon source may be measured by a gas or liquid displacement. In certain aspects, the volume of material in the carbon source may be estimated by a linear gauge—for example, in certain embodiments the carbon source has a fixed area and additional material accumulates in the vertical direction, like a silo; in such an aspects, the volume of carbon material may be estimated by measuring the height of the material in the carbon source. In various aspects this height measurement may be accomplished using a laser gauge, an optical gauge, a dial gauge, a dilatometer, or other means of linear measurement known in the art. Measurement methods described above may be combined to provide redundancy and/or to improve overall measurement accuracy.

In an aspect, the fuel gauge can be configured to sense the CO/CO₂ tank. The fuel gauge can be configured to determine a mass of CO/CO₂ in the CO/CO₂ tank, a pressure of CO/CO₂ in the CO/CO₂ tank, or a combination thereof. In some aspects, the system can comprise the carbon sensor and the CO/CO₂ sensor. In certain aspects, the fuel gauge can combine measurements of both the carbon source and the gas tank to improve the accuracy of the fuel gauge estimation and/or to ensure redundancy in the event that one measurement fails or is compromised. In certain aspects, discrepancies in the measurements of the carbon source and gas tank measurements may be used to signal that the system requires service or repair.

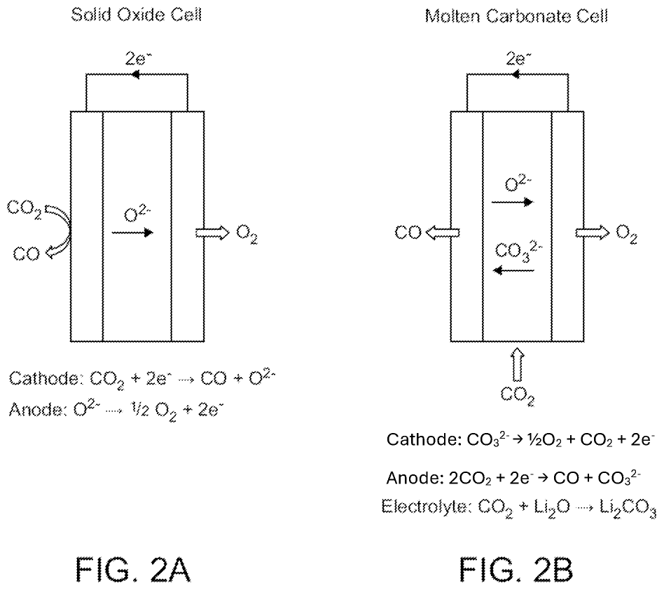

Referring to FIG. 2A, in some aspects, the electrochemical cell can be a solid oxide cell, which uses a solid-state oxygen-anion (O²⁻) conducting electrolyte. The reactions occurring at the cathode and the anode during charging of the solid oxide electrochemical cell are shown in FIG. 2A. In other embodiments, the electrochemical cell can be a molten carbonate cell, which uses a carbonate anion (CO₃²⁻) conducting electrolyte, as shown in FIG. 2B. The reactions occurring at the cathode, the anode, and the electrolyte during charging of the molten carbonate electrochemical cell are shown in FIG. 2B. Other types or combinations of cell types may be used for the electrochemical cells.

The carbon-oxygen battery system may include at least one removable electrochemical cell and may include multiple removable electrochemical cells. A plurality of electrochemical cells may be used in the form of an electrochemical cell stack, e.g., to provide a selected voltage, in which the electrochemical cells are interconnected to form a “stack”. The entire stack may be removable from the carbon-oxygen battery system. Also mentioned is a configuration in which the individual electrochemical cells of a stack are removable from the carbon-oxygen battery system.

In an aspect, the removable electrochemical cell, when present, can be configured to be selectively isolated from the carbon-oxygen battery system. Preferably, the removable electrochemical cell can be configured to be selectively isolated from the carbon-oxygen battery system. In various aspects, it is possible to isolate the cell electrically, fluidically, mechanically, or thermally, and/or combinations and permutations thereof. In an aspect, each removable electrochemical cell can be configured to be independently isolated from the system. In another aspect, a grouping comprising a plurality of electrochemical cells can be isolated from the system; such a grouping can be advantageous because it reduces the cost of components and materials required to isolate electrochemical cells from the overall system. In certain aspects, the carbon-oxygen battery system can be configured to operate when one or more of the removable electrochemical cells is isolated from the system and at least one electrochemical cell is not isolated from the system. In certain aspects, the carbon-oxygen battery system may not be operable when removable electrochemical cells are isolated from the system.

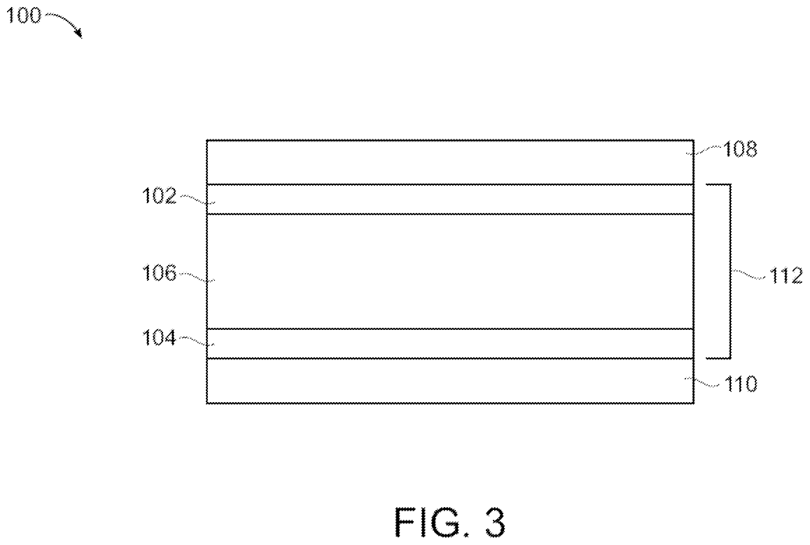

Referring to FIG. 3, an electrochemical cell 100 is shown. The electrochemical cell 112 includes a positive electrode 102, a negative electrode 104, and an electrolyte 106 disposed between the positive electrode 102 and the negative electrode 104. In some embodiments, the electrochemical cell 100 may further include a positive interconnect 108 in contact with the positive electrode 102 and a negative interconnect 110 in contact with the negative electrode 104. The positive interconnect 108 and the negative interconnect 110 may be used to connect the positive electrodes and negative electrodes, respectively, between multiple electrochemical cells. In some embodiments, the interconnects 108, 110 may be current collectors for the respective electrodes.

The interconnects 108, 110 may be connected to an external circuit 240 for charging or discharging of the carbon-oxygen battery 200. The interconnects 108, 110 may be connected to other electrical features by welding or soldering connections. In some embodiments, the interconnects 108, 110 may be connected to other electrical features by mechanical pressure fittings, which include bolted, spring loaded, or other suitable mechanical contacting terminals.

In some embodiments, the interconnects 108, 110 may have surfaces that are coated with an oxidation resistant coating. The oxidation resistant coating can include nickel (Ni), nickel-alloys, chrome (Cr), chrome-alloys, gold (Au), and/or other oxidation resistant, conductive materials. The electrical interfaces can be coated with a joint compound. The joint compounds can be a liquid or gel component that covers the exposed metallic surface to prevent corrosion and/or passivation.

The positive electrode 102 of the electrochemical cell 112 may be any suitable oxygen electrode. Exemplary positive electrode materials include lanthanum strontium cobalt ferrite (LSCF), strontium-doped lanthanum manganate, strontium oxide and bismuth oxide doped with lanthanum manganate, lanthanum strontium cobaltite (LSC), barium strontium iron cobaltite (BSCF), strontium doped hafnium oxide, europium cobaltite (SSC), or the like, or a combination thereof. In some embodiments, the positive electrode may include lanthanum strontium cobalt ferrite (LSCF). In other embodiments, the positive electrode may include Bi₂O₃-MO (wherein M is one or more of Ca, Sr, Ba, or Cu), Bi₂O₃-MO₂ (wherein M is one or more of Ti, Zr, or Te), Bi₂O₃-MO₃ (wherein M is one or more of W or Mo), Bi₂O₃-M₂O₅ (wherein M is one or more of V, Nb, or Ta), Bi₂O₃-M₂O₃ (wherein M is one or more of La, Sm, Y, Gd, or Er), nickel, a lithiated nickel oxide, or a combination thereof

The negative electrode 104 of the electrochemical cell 112 may be any suitable anode material. The negative electrode 104 may include an electron-conducting material and ceria doped with one or more rare earth elements such as Gd, Sm, Pr, La, Y, or Yb, and/or one or more other elements such as Mn or Fe. The electron-conducting material may include ceramic oxides such as Sr-doped lanthanum chromite, Nb-, La-, or Y-doped strontium titanate, strontium iron molybdate, or the like, or a combination thereof, and/or metals such as copper, silver, or the like, or a combination thereof. Exemplary negative electrode materials includes nickel oxide (NiO), cerium oxide (CeO₂), copper oxide (CuO), strontium titanate (SrTiO₃), yttrium oxide doped strontium titanate (YST), thorium oxide doped strontium titanate (SST), or the like, or a combination thereof. Other exemplary negative electrode materials may include ceramic oxides such as lanthanum strontium chromite, strontium iron molybdate, copper, silver, or the like, or a combination thereof.

The electrolyte 106 is disposed between the positive electrode 102 and the negative electrode 104. Any suitable electrolyte material, or combination of materials, may be used. In some embodiments, the electrolyte may include a solid oxide electrolyte, a molten carbonate electrolyte, or a combination thereof.

Exemplary solid oxide electrolytes include yttrium oxide stabilized zirconia (YSZ), hafnium oxide stabilized zirconia (SSZ), hafnium oxide doped cerium oxide (GDC), hafnium oxide doped cerium oxide (SDC), strontium and magnesium doped lanthanum gallate (LSGM), yttrium oxide doped cerium oxide (YDC), strontium oxide, magnesium oxide, Li₂₊₂ₓZn_{1-X}GeO₄, Li-β-alumina, lithium phosphorus oxynitride (LiPON), Li_{1.3}Al_{0.3}Ti_{1.7}(PO₄)₃, LaGaO₃-containings oxides, Sr(Ce, Yb)O₃-containing oxides, BaCeO₃-containing oxides, perovskite oxides, (Ba,La,Sr)₂In₂O₅-containing oxides, LaCeMgO₃-containing oxides, or the like, or a combination thereof.

Exemplary molten carbonate electrolytes include Li—K molten carbonate electrolyte, Li—Na molten carbonate electrolyte, Li—K—Na molten carbonate electrolyte, or the like, or a combination thereof.

In an aspect, the electrochemical cell may include a multilayered electrolyte including a first layer and a second layer, wherein the first layer and the second layer are different from each other. For example, the first layer may include a first electrolyte including a first solid oxygen conductor, and the second layer may include a second electrolyte including a second solid oxygen conductor electrolyte different from the first solid oxygen ion conductor in composition, form, or both.

Additional details of the electrochemical cell can be determined by one of skill in the art without undue experimentation, and are also available in The Handbook of Fuel Cells—Fundamentals, Technology, and Applications, W. Vielstich, H. A. Gasteiger, and A. Lamm, Eds., 2010, the content of which is incorporated herein by reference in its entirety, for example.

The carbon-oxygen battery system can further comprise a thermal chamber. For example, the Boudouard reactor, the electrochemical cell, or both can be disposed in a thermal chamber. In an aspect, the stack including a plurality of removable electrochemical cells may be disposed within a thermal chamber. In an aspect, Boudouard reactor may be disposed in a thermal chamber, which may be the same thermal chamber as the electrochemical cell, but embodiments are not limited thereto, and the Boudouard reactor may also be disposed in a separate thermal chamber from the electrochemical cell.

In an aspect, a plurality of thermal chambers may be used. For example, in an aspect the carbon-oxygen battery system can comprise a plurality of electrochemical cells, and can further comprise a plurality of thermal chambers. In an aspect, the Boudouard reactor can be disposed in a first thermal chamber of the plurality of thermal chambers. At least one electrochemical cell of the plurality of electrochemical cells can be disposed in a second thermal chamber of the plurality of thermal chambers.

Any suitable thermal chamber may be used. The thermal chamber may be configured to provide a desired operating temperature for the removable electrochemical cell, the Boudouard reactor, or both. By using separate thermal chambers for the electrochemical cell (or stack thereof) and the Boudouard reactor, it may be possible to deactivate the heating function to selective parts of the carbon-oxygen battery system when replacing a removable electrochemical cell (or stack thereof), without disturbing the heating function in the other removable electrochemical cells.

The thermal chamber may be configured to provide and maintain any desirable temperature. In an aspect, the thermal chamber may be configured to provide an operating temperature that is greater than 400° C., greater than 500° C., greater than 700° C., or greater than 1000° C. For example, the thermal chamber may maintain a temperature of 400° C. to 1,500° C., or 500° C. to 1,000° C.

In an aspect, the carbon-oxygen battery system can further comprise a heat exchanger. Without wishing to be bound by theory, it is believed that the presence of the heat exchanger can increase the efficiency of the carbon-oxygen battery system by exchanging heat between the Boudouard reactor and the electrochemical cell. Thus, when present, the heat exchanger can be configured to exchange heat between the Boudouard reactor and the electrochemical cell. In an aspect, the carbon-oxygen battery system can further comprise a heat exchanger which can be contact with the carbon source. For example, the heat exchanger can be in thermal contact with the carbon source.

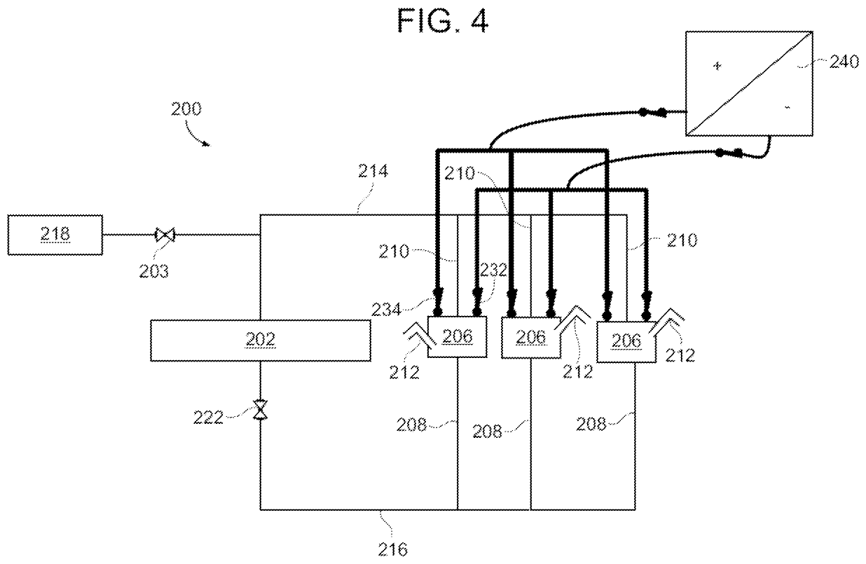

Referring to FIG. 4, a carbon-oxygen battery system 200 according to an aspect of the present disclosure is shown. The carbon-oxygen battery system 200 includes a Boudouard reactor 202 in fluid communication with electrochemical cell 206. The electrochemical cell 206 has a CO/CO₂ inlet 208, a CO/CO₂ outlet 210 and an oxygen outlet 212. The CO/CO₂ outlet 210 is fluidly connected by a first stream 214 to an inlet of the Boudouard reactor 202, and the CO/CO₂ inlet 208 is fluidly connected by a second stream 216 to an outlet of the Boudouard reactor 202. The carbon-oxygen battery system 200 also includes a CO/CO₂ tank 218 fluidly connected to at least one of the first stream 214 or the second stream 216.

As noted above, the carbon-oxygen battery system is configured to be charged by supplying electricity and carbon dioxide gas to the battery, and to be discharged by converting elemental carbon in its solid form to carbon dioxide gas, thereby generating electricity. It is to be understood that the Boudouard reactor 202 is configured to reversibly precipitate solid carbon from carbon-monoxide gas (2 CO→C+CO2) and to gasify solid carbon into carbon monoxide (C+CO2→2CO), and thus serve as both a source for elemental carbon and as storage for elemental carbon that is produced. It is to be further understood that in some aspects a separate carbon source can be included in which the carbon source can be configured to reversibly store solid carbon, and thus serve as both a source for elemental carbon and as storage for elemental carbon that is produced. It is to be further understood that the CO/CO₂ reservoir 218 is configured to reversibly store carbon dioxide and carbon monoxide, and thus serve as both a source for carbon dioxide and carbon monoxide and as storage for carbon dioxide and carbon monoxide that is produced.

The CO/CO₂ tank 218 of the carbon-oxygen battery system is configured to store a mixture of carbon dioxide (CO₂) and carbon monoxide (CO) gasses. Other gases may be present, for example N₂, He, Ar, or a combination thereof. The ratio of CO/CO₂ and the total quantity of gas can vary as the battery system charges and discharges. Thus, insofar as the CO/CO₂ tank 218 may be regarded as a fixed volume tank, the pressure of the gas stored in the tank can vary as the battery system charges and discharges.

In some aspects, the CO/CO₂ tank 218 can be a pressurized storage tank. The pressure of the gas in the storage tank can be from 0.34 megapascal (MPa) to 13.8 MPa. During discharge of the carbon-oxygen battery system 200, the carbon dioxide and carbon monoxide produced can be discharged to the surrounding environment or alternatively stored via discharge to the second stream 216.

The carbon-oxygen battery 200 includes one or more electrochemical cells 206. In an aspect, the electrochemical cell 206 can be removable from the carbon-oxygen battery 200, as described above. As noted previously, in the carbon-oxygen battery 200, a plurality of electrochemical cells 206 may be in the form of an electrochemical cell stack. For the sake of convenience, the electrochemical cells 206 may refer to stacks that each include a plurality of electrochemical cells. The electrochemical cell 206 can be removable from the carbon-oxygen battery 200. Mentioned is a configuration in which the electrochemical cell stack, including the plurality of electrochemical cells, may be removable as a stack.

The electrochemical cell 206 has a CO/CO₂ inlet 208, a CO/CO₂ outlet 210 and an oxygen outlet 212. The CO/CO₂ outlet is fluidly connected by a first stream 214 to an inlet of the Boudouard reactor 202, and the CO/CO₂ inlet is fluidly connected by a second stream 216 to an outlet of the Boudouard reactor 202. In some aspects, the electrochemical cell 206 may be configured to be selectively isolated from the carbon-oxygen battery system. For example, a gas supply valve may be used to isolate the electrochemical cell 206 from the second stream 216.

The carbon-oxygen battery 200 includes a Boudouard reactor 202 that is in fluid communication with the electrochemical cell 206. The Boudouard reactor 202 may be configured to be selectively isolated from the carbon-oxygen battery system, for example to repair or replace the Boudouard reactor 202. For example, a valve 222 may be used to isolate the electrochemical cell 206 from the Boudouard reactor 202.

In some aspects, the Boudouard reactor 202 may be configured to include a flow control valve 203 to maintain, monitor, and adjust the flow of carbon dioxide and carbon monoxide from the CO/CO₂ tank 218. In some aspects, the valve 203 may be a flow control valve. The flow control valve 203 can be configured to determine an amount of carbon dioxide in the stream.

The Boudouard reactor 202 may also be in fluid communication with the second stream 214. The Boudouard reactor 202 may be configured to be selectively isolated from the second stream 214. For example, a valve may be used to isolate the Boudouard reactor 202 from the second stream 214.

The electrochemical cells of the carbon-oxygen battery system can further be in fluid communication with a source of oxygen, e.g., air, and a vent for oxygen. For example, the source of oxygen may be ambient air, compressed air, or oxygen gas. In certain aspects, the oxygen gas stream can be pre-heated before it enters the electrochemical cell. In certain aspects, the oxygen gas stream may not be pre-heated before it enters the electrochemical cell and instead can be heated by exchange of heat from the electrochemical cell into the gas phase. The oxygen may be delivered by any suitable means to the electrochemical cells, such as (and without limitation) a pump, blower, or compressor. In certain aspects the oxygen gas stream is distributed to multiple electrochemical cells through a manifold. As shown in FIG. 4, the removable electrochemical cell 206 may be in fluid communication with a vent port 212. The vent port 212 may be configured to release oxygen gas that is generated during charging of the carbon-oxygen battery 200.

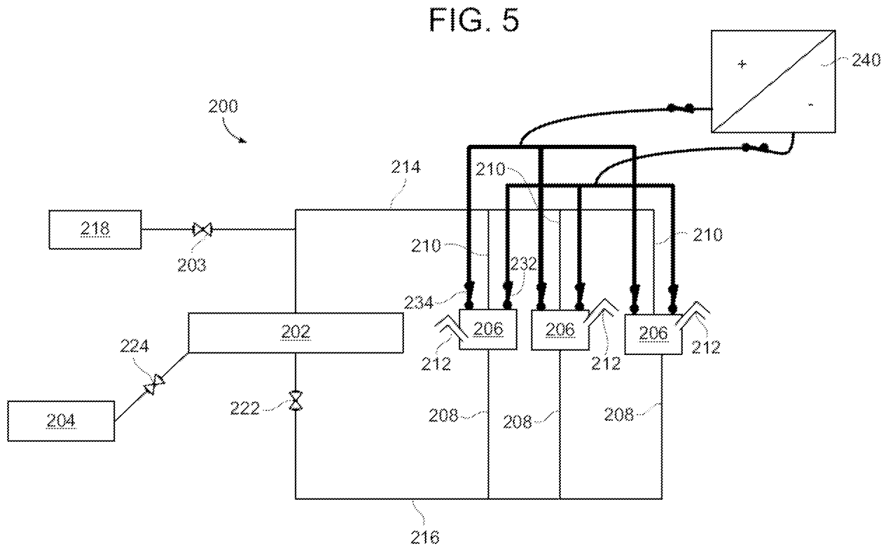

Referring to FIG. 5, the carbon-oxygen battery system can further comprise a carbon source 204 in fluid communication with the Boudouard reactor 202. In an aspect, the Boudouard reactor 202 can be configured to be selectively isolated from the carbon source 204. For example, a carbon source supply valve 224 may be used to isolate the Boudouard reactor 202 from the carbon source 204.

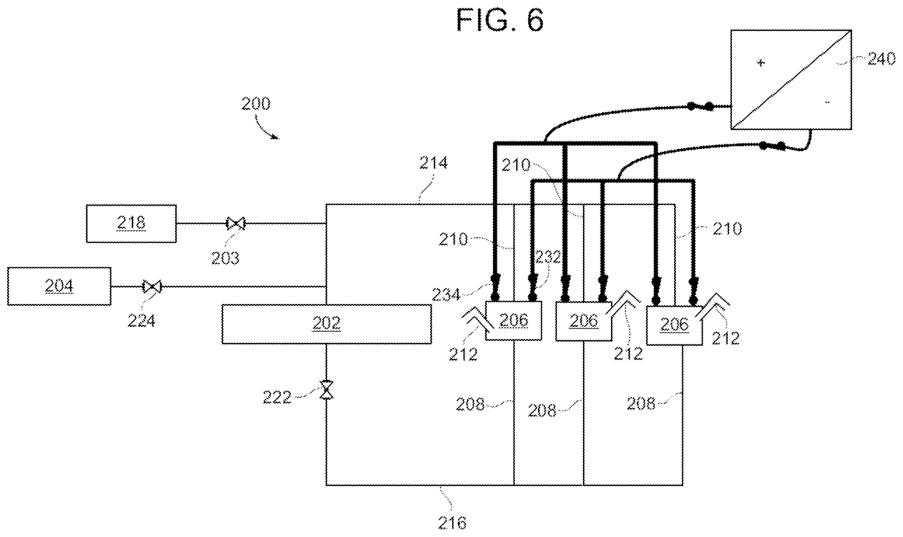

Referring to FIG. 6, the carbon-oxygen battery system can further comprise a carbon source 204 in fluid communication with the Boudouard reactor 202, wherein the carbon source 204 is fluidically connected to the electrochemical cell 206 via the first stream 214. The carbon source 204 can be selectively isolated from the electrochemical cell 206, for example via a carbon source supply valve 224.

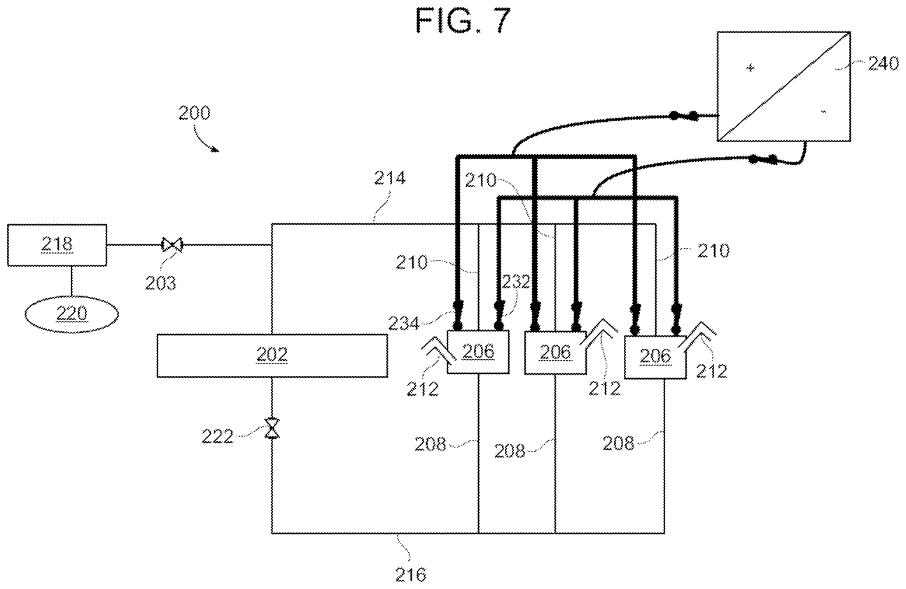

Referring to FIG. 7, the carbon-oxygen battery system 200 can further comprise a fuel gauge 220, wherein the fuel gauge is configured to sense the CO/CO₂ tank. For example, the fuel gauge 220 can be configured to determine a mass of CO/CO₂ in the CO/CO₂ tank 218, a pressure of CO/CO₂ in the CO/CO₂ tank 218, or a combination thereof.

In some aspects, the CO/CO₂ sensor 220 can be a pressure transducer. The pressure transducer can be integrated into, disposed on, or positioned downstream of the CO/CO₂ tank 218. The pressure transducer 220 can be configured to determine the quantity of gaseous species in the system (e.g., CO and CO₂), which is an indicator of the state of charge of the system (i.e. a fuel gauge). For example, when the system is fully discharged, there is no solid carbon. Only gaseous species (e.g., carbon dioxide and carbon monoxide) is present and the volume of gas stored in the system is at a maximum. Conversely, when the system is fully charged, there is no gaseous species present, and all carbon atoms are stored as solid carbon (e.g., in the Boudouard reactor) and the gas pressure is at a minimum. In some aspects, as the system discharges, the gas phase volume will increase. Conversely, as the system is charged, the gas phase volume will decrease. Thus, the measurement of the volume of the gas phase may be used as a fuel gauge indicator, and this may be accomplished by measuring the pressure in the CO/CO₂ tank 218.

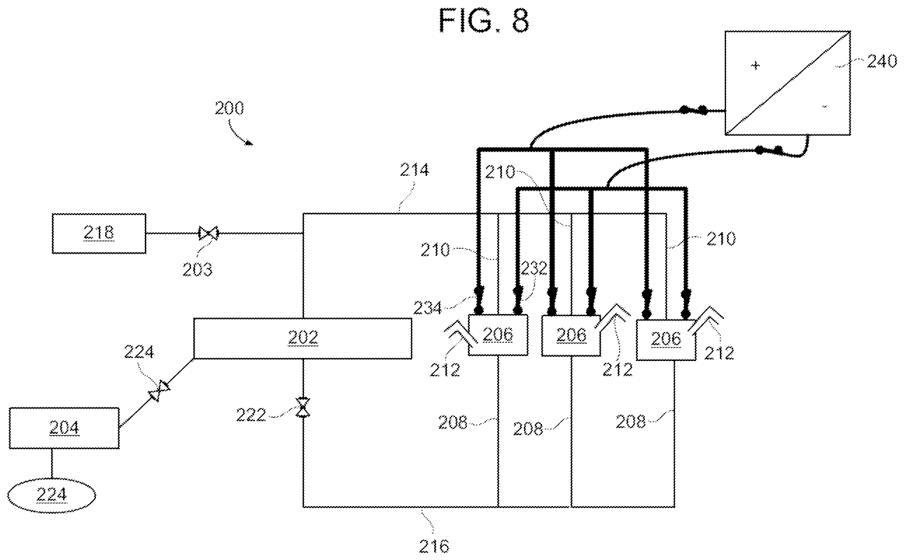

Referring to FIG. 8, in some aspects the carbon source 204 of the carbon-oxygen battery system 200 can further comprise a fuel gauge 224. Fuel gauge 224 can be configured to sense the carbon source. For example, the fuel gauge 224 can be configured to determine a mass of carbon in the carbon source, a volume of carbon in the carbon source, or a combination thereof. Exemplary carbon sensors 224 can include a weighing device such as a balance, or a scale, or a load cell. For example, as the system is more discharged, the mass of solid carbon in the carbon source 204 will be lower. Conversely, as the system is more highly charged the mass of solid carbon in the carbon source 204 will be greater. Thus, the measurement of the mass of solid carbon in the carbon source 204 may be used as a fuel gauge indicator.

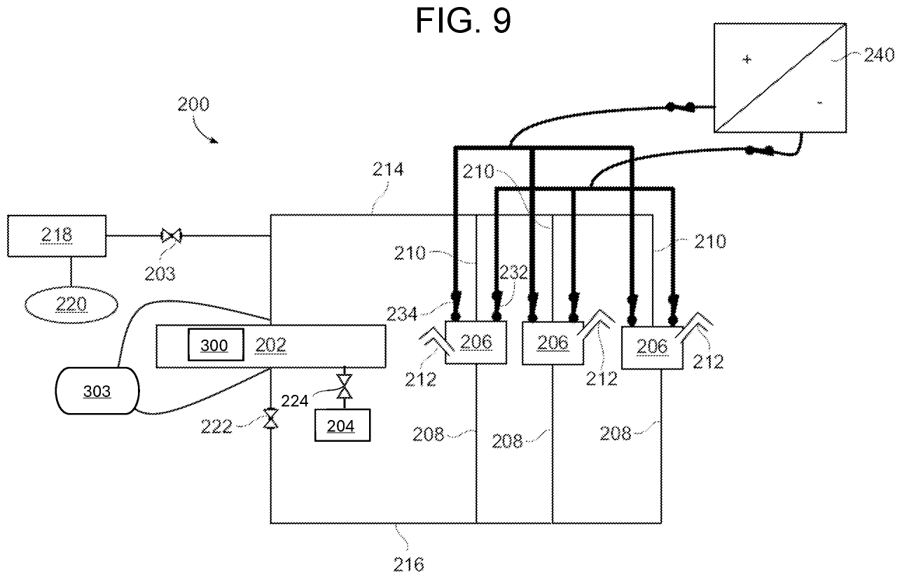

In an aspect, the Boudouard reactor 202 can comprise a carbon store 300 that serves as both a source for elemental carbon and as storage for elemental carbon that is produced. Accordingly, the deposition or gasification of carbon can occur within the Boudouard reactor. As gasses flow through the Boudouard reactor, the produced pressure changes (e.g. a pressure drop) can be measured. As shown in FIG. 9, a fuel gauge 303 can be configured to determine a state of charge based on a pressure drop through the Boudouard reactor 202. The pressure drop can be determined between the inlet and outlet of the Boudouard reactor 202 by a fuel gauge 303. In an aspect, the carbon store 300 can be configured to provide carbon to the carbon-oxygen battery system. The carbon-oxygen battery system can further comprise a carbon source 204 external to the Boudouard reactor 202. A method of operating the carbon-oxygen battery can include storing carbon, produced by charging, in the carbon store. The method of operating the carbon-oxygen battery can further include determining the state of charge of the carbon-oxygen battery system using the fuel gauge, which senses the pressure drop across the Boudouard reactor. In an aspect, the method of operating the carbon-oxygen battery can include determining the pressure drop between the inlet and the outlet of the Boudouard reactor. The determining the state of charge can be during the discharging of the battery system, during the charging of the battery system, or a combination thereof.

The positive electrode and the negative electrode of the electrochemical cell or stack of electrochemical cells are connected to an external circuit 240. The electrochemical cell can be configured to be selectively isolated from the external circuit. When a plurality of electrochemical cells are present, they may be connected in any suitable combination of series and/or in parallel connections to form an assembly of cells (i.e., a “stack”). In an aspect, each electrochemical cell of the plurality of electrochemical cells can be electrically connected to an external circuit in parallel. Electrical switches 232, 243 may be used to selectively isolate the electrochemical cell from the external circuit 240. The carbon-oxygen battery system may be further connected to a power management controller in electrical communication with the electrochemical cells and configured to control a charge or a discharge of each electrochemical cell.

Accordingly, the electrochemical cell can be configured to be selectively isolated from the Boudouard reactor, the carbon source, the CO/CO₂ tank, the first stream, the second stream, the external circuit, or a combination thereof. In an aspect, the electrochemical cell may be selectively isolated from the Boudouard reactor by an operating valve, selectively isolated from the first stream and/or the second stream by an operating valve, and/or selectively isolated from the external circuit by operating switches.

In an aspect, the battery system may include a plurality of removable electrochemical cells, wherein each of the removable electrochemical cells, or each removeable electrochemical cell stack, is independently in fluid communication with the Boudouard reactor and the carbon dioxide supply stream, and each of the removable electrochemical cells is independently in electrical contact with the external circuit. In an aspect, each removable electrochemical cell may be configured to be independently isolated from each Boudouard reactor, the carbon dioxide supply stream, and the external circuit; wherein the carbon-oxygen battery system may be configured to operate when one or more removable electrochemical cells is isolated from the Boudouard reactor, the carbon dioxide supply stream, the external circuit, or a combination thereof; and wherein at least one electrochemical cell of the plurality of removable electrochemical cells is not isolated from the Boudouard reactor, the carbon dioxide supply stream, and the external circuit. In other words, the carbon-oxygen battery system can be configured to operate when at least one removable electrochemical cell is operational and the other removable electrochemical cells of the plurality of electrochemical cells are being replaced or repaired.

Also provided is a method of operating the carbon-oxygen battery system as described herein. The method may include supplying electricity and a CO/CO₂ stream to the carbon-oxygen battery system to charge the battery system. The CO/CO₂ stream can be provided by the CO/CO₂ tank. Carbon dioxide from the CO/CO₂ stream is converted to carbon monoxide and oxygen by the electrochemical cell. The carbon monoxide from the electrochemical cell is converted to carbon dioxide and carbon in a Boudouard reaction. The carbon produced by the charging is stored in a carbon source (which may be the Boudouard reactor as described above). The method can further comprise discharging the battery system to convert the carbon to carbon dioxide and produce electricity. The carbon and carbon dioxide are converted in a Boudouard reaction to carbon monoxide. The carbon monoxide and oxygen are converted to carbon dioxide by the electrochemical cell, and the carbon dioxide is added to the CO/CO₂ stream. The CO/CO₂ produced by the discharging can be stored in the CO/CO₂ tank. In an aspect, the method can further comprise accumulating the carbon dioxide produced by the electrochemical cell in the CO/CO₂ tank. The CO/CO₂ stream can comprise CO, CO₂, N₂, He, Ar, or a combination thereof. In an aspect, the CO/CO₂ stream comprises at least one of CO and CO₂, and optionally further comprises N₂, He, Ar, or a combination thereof.

In an aspect, a method of operating a carbon-oxygen battery system can comprise providing a carbon-oxygen battery system. The carbon-oxygen batter system can comprise a Boudouard reactor in fluid communication with an electrochemical cell, wherein the electrochemical cell has a CO/CO₂ inlet, a CO/CO₂ outlet and an oxygen outlet, wherein the CO/CO₂ outlet is fluidly connected by a first stream to an inlet of the Boudouard reactor, and wherein the CO/CO₂ inlet is fluidly connected by a second stream to an outlet of the Boudouard reactor; and a CO/CO₂ tank fluidly connected to at least one of the first stream or the second stream. The method further comprises supplying electricity and a CO/CO₂ stream to the carbon-oxygen battery system to charge the battery system, wherein the CO/CO₂ stream is provided by the CO/CO₂ tank, carbon dioxide from the CO/CO₂ stream is converted to carbon monoxide and oxygen by the electrochemical cell, the carbon monoxide from the electrochemical cell is converted to carbon dioxide and carbon in a Boudouard reaction, and the carbon produced by the charging is stored in a carbon source. The method can further comprise discharging the battery system to convert the carbon to carbon dioxide and produce electricity, wherein the carbon and carbon dioxide are converted in a Boudouard reaction to carbon monoxide, the carbon monoxide and oxygen are converted to carbon dioxide by the electrochemical cell, the carbon dioxide is added to the CO/CO₂ stream, and the CO/CO₂ produced by the discharging is stored in the CO/CO₂ tank.

In an aspect, a method of operating a carbon-oxygen battery system can comprise providing a carbon-oxygen battery system as described herein, and installing a removable electrochemical cell to operate the system. In an aspect, the installing can occur while charging or discharging an electrochemical cell.

In an aspect, a method of operating a carbon-oxygen battery system can comprise providing the carbon-oxygen battery system as described herein, and isolating a removable electrochemical cell, wherein the isolating comprises closing a first valve at a position downstream of the CO/CO₂ tank and upstream of the removable electrochemical cell, closing a second valve at a position downstream of the Boudouard reactor, and disconnecting the removable electrochemical cell from the external circuit to isolate the removable electrochemical cell to operate the system.

During isolation of the removable electrochemical cell, the removable electrochemical cell can be isolated by closing a first valve at a position downstream of the CO/CO₂ tank and upstream of the removable electrochemical cell, closing a second valve at a position downstream of the Boudouard reactor, and disconnecting the electrochemical cell from the external circuit to isolate the first electrochemical cell. In other aspects, the method can include installing a first removable electrochemical cell while charging or discharging a second removable electrochemical cell to operate the carbon-oxygen battery system. Installing a first removable electrochemical cell can include opening the first valve at a position downstream of the CO/CO₂ tank and upstream of the first removable electrochemical cell, opening a second valve at a position downstream of the Boudouard reactor, and connecting the first electrochemical cell to the external circuit.

Also provided is a method of operating a carbon-oxygen battery system as described herein. In an aspect, the method may include determining an amount of carbon in the Boudouard reactor, determining an amount of gas in the gas storage tank, determining a ratio of carbon monoxide to carbon dioxide in the gas phase, determining a ratio of carbon monoxide to carbon dioxide in the carbon dioxide supply stream, or a combination thereof.

The disclosed method provides a battery system with a longer lifetime. For example, a battery system can have a lifespan of 20 years while a replaceable cell can have a shorter lifetime (e.g., 1 year, 3 years, 5 years, or 10 years).

Still another aspect provides a method of manufacturing the carbon-oxygen battery system as described herein. The method can comprise providing a Boudouard reactor in fluid communication with an electrochemical cell, wherein the electrochemical cell having a CO/CO₂ inlet, a CO/CO₂ outlet and an oxygen outlet, wherein the CO/CO₂ outlet is fluidly connected by a first stream to an inlet of the Boudouard reactor, and wherein the CO/CO₂ inlet is fluidly connected by a second stream to an outlet of the Boudouard reactor. The method can further comprise providing a CO/CO₂ tank fluidly connected to at least one of the first stream or the second stream to manufacture the carbon-oxygen battery system. The method can further comprise disposing a first valve between the electrochemical cell and the CO/CO₂ tank; and disposing a second valve between the electrochemical cell and the Boudouard reactor. Other components and features described herein may be incorporated using any suitable method and in any sequence of steps.

This disclosure further encompasses the following aspects.

Aspect 1: A carbon-oxygen battery system, comprising: a Boudouard reactor in fluid communication with an electrochemical cell, wherein the electrochemical cell has a CO/CO₂ inlet, a CO/CO₂ outlet, and an oxygen outlet, and wherein the CO/CO₂ outlet is fluidly connected by a first stream to an inlet of the Boudouard reactor, and wherein the CO/CO₂ inlet is fluidly connected by a second stream to an outlet of the Boudouard reactor; and a CO/CO₂ tank fluidly connected to at least one of the first stream or the second stream.

Aspect 2: The carbon-oxygen battery system of aspect 1, further comprising a carbon source in fluid communication with the Boudouard reactor.

Aspect 3: The carbon-oxygen battery system of aspect 1, further comprising a carbon source, and a conveyance member configured to convey carbon between the Boudouard reactor and the carbon source.

Aspect 4: The carbon-oxygen battery system of aspect 2, wherein the carbon source is fluidically connected to the electrochemical cell via the first stream or the second stream.

Aspect 5: The carbon-oxygen battery system of aspect 1, wherein the carbon source is fluidically connected to the first stream or the second stream between the Boudouard reactor and at least one of the CO/CO₂ inlet or the CO/CO₂ outlet of the electrochemical cell.

Aspect 6: The carbon-oxygen battery system of aspect 1, further comprising a fuel gauge.

Aspect 7: The carbon-oxygen battery system of aspect 6, wherein the fuel gauge is configured to sense the carbon source, and wherein the fuel gauge is a carbon sensor configured to determine a mass of carbon in the carbon source, a volume of carbon in the carbon source, or a combination thereof.

Aspect 8: The carbon-oxygen battery system of aspect 6, wherein the fuel gauge is configured to sense the CO/CO₂ tank, and wherein the fuel gauge is configured to determine a mass of CO/CO₂ in the CO/CO₂ tank, a pressure of CO/CO₂ in the CO/CO₂ tank, or a combination thereof.

Aspect 9: The carbon-oxygen battery system of any of aspects 1 to 8, wherein the electrochemical cell comprises a plurality of electrochemical cells, and wherein at least one electrochemical cell of the plurality of electrochemical cells is a removable electrochemical cell.

Aspect 10: The carbon-oxygen battery system of aspect 9, wherein the removable electrochemical cell is configured to be selectively isolated from the carbon-oxygen battery system, preferably wherein the removable electrochemical cell is configured to be selectively isolated from the carbon-oxygen battery system.

Aspect 11: The carbon-oxygen battery system of aspects 9 to 10, wherein each electrochemical cell of the plurality of electrochemical cells is in electrical contact with the external circuit.

Aspect 12: The carbon-oxygen battery system of any of aspects 9 to 11, wherein each removable electrochemical cell of the plurality of removable electrochemical cells is electrically connected to the external circuit in parallel.

Aspect 13: The carbon-oxygen battery system of any of aspects 1 to 12, wherein the electrochemical cell comprises a positive electrode, a negative electrode, and an electrolyte, wherein the positive electrode and the negative electrode are connected to an external circuit.

Aspect 14: The carbon-oxygen battery system of aspect 13, wherein the electrolyte comprises a solid oxide electrolyte, a molten carbonate electrolyte, or a combination thereof.

Aspect 15: The carbon-oxygen battery system of any of aspects 1 to 14, wherein the electrochemical cell comprises a multilayered electrolyte comprising a first layer and a second layer, wherein the first layer and the second layer are different.

Aspect 16: The carbon-oxygen battery system of any of aspects 9 to 15, wherein each removable electrochemical cell is configured to be independently isolated from the system, and wherein the carbon-oxygen battery system is configured to operate when one or more of the removable electrochemical cells is isolated from the system and at least one electrochemical cell is not isolated from the system.

Aspect 17: The carbon-oxygen battery system of any of aspects 1 to 16, wherein the Boudouard reactor or the electrochemical cell is disposed in a thermal chamber.

Aspect 18: The carbon-oxygen battery system of any of aspects 1 to 17, further comprising a heat exchanger configured to exchange heat between the Boudouard reactor and the electrochemical cell.

Aspect 19: The carbon-oxygen battery system of any of aspects 1 to 18, wherein the battery system comprises a plurality of electrochemical cells, wherein the battery system further comprises a plurality of thermal chambers, and wherein the Boudouard reactor is disposed in a first thermal chamber of the plurality of thermal chambers, and at least one electrochemical cell of the plurality of electrochemical cells is disposed in a second thermal chamber of the plurality of thermal chambers.

Aspect 20: A method of operating the carbon-oxygen battery system of any of aspects 1 to 19, the method comprising: supplying electricity and a CO/CO₂ stream to the carbon-oxygen battery system to charge the battery system, wherein the CO/CO₂ stream is provided by the CO/CO₂ tank, carbon dioxide from the CO/CO₂ stream is converted to carbon monoxide and oxygen by the electrochemical cell, the carbon monoxide from the electrochemical cell is converted to carbon dioxide and carbon in a Boudouard reaction, and the carbon produced by the charging is stored in a carbon source; and discharging the battery system to convert the carbon to carbon dioxide and produce electricity, wherein the carbon and carbon dioxide are converted in a Boudouard reaction to carbon monoxide, the carbon monoxide and oxygen are converted to carbon dioxide by the electrochemical cell, the carbon dioxide is added to the CO/CO₂ stream, and the CO/CO₂ produced by the discharging is stored in the CO/CO₂ tank.

Aspect 21: The method of aspect 20, further comprising accumulating the carbon dioxide in the CO/CO₂ tank.

Aspect 22: A method of operating a carbon-oxygen battery system, the method comprising: providing a carbon-oxygen battery system comprising a Boudouard reactor in fluid communication with an electrochemical cell, wherein the electrochemical cell has a CO/CO₂ inlet, a CO/CO₂ outlet and an oxygen outlet, wherein the CO/CO₂ outlet is fluidly connected by a first stream to an inlet of the Boudouard reactor, and wherein the CO/CO₂ inlet is fluidly connected by a second stream to an outlet of the Boudouard reactor; and a CO/CO₂ tank fluidly connected to at least one of the first stream or the second stream; supplying electricity and a CO/CO₂ stream to the carbon-oxygen battery system to charge the battery system, wherein the CO/CO₂ stream is provided by the CO/CO₂ tank, carbon dioxide from the CO/CO₂ stream is converted to carbon monoxide and oxygen by the electrochemical cell, the carbon monoxide from the electrochemical cell is converted to carbon dioxide and carbon in a Boudouard reaction, and the carbon produced by the charging is stored in a carbon source; and discharging the battery system to convert the carbon to carbon dioxide and produce electricity, wherein the carbon and carbon dioxide are converted in a Boudouard reaction to carbon monoxide, the carbon monoxide and oxygen are converted to carbon dioxide by the electrochemical cell, the carbon dioxide is added to the CO/CO₂ stream, and the CO/CO₂ produced by the discharging is stored in the CO/CO₂ tank.

Aspect 23: The method of any of aspects 20 to 22, wherein the CO/CO₂ stream comprises CO, CO₂, N₂, He, Ar, or a combination thereof.

Aspect 24: A method of operating a carbon-oxygen battery system, the method comprising: providing the carbon-oxygen battery system of any of aspects 1 to 19; and installing a removable electrochemical cell to operate the system.

Aspect 25: The method of aspect 24, wherein the installing occurs while charging or discharging an electrochemical cell.

Aspect 26: A method of operating a carbon-oxygen battery system, the method comprising: providing the carbon-oxygen battery system of any of aspects 1 to 19; and isolating a removable electrochemical cell, wherein the isolating comprises closing a first valve at a position downstream of the CO/CO₂ tank and upstream of the removable electrochemical cell, closing a second valve at a position downstream of the Boudouard reactor, and disconnecting the removable electrochemical cell from the external circuit to isolate the removable electrochemical cell to operate the system.

Aspect 27: A method of manufacturing the carbon-oxygen battery system of any of aspects 1 to 19, the method comprising: providing a Boudouard reactor in fluid communication with an electrochemical cell, wherein the electrochemical cell having a CO/CO₂ inlet, a CO/CO₂ outlet and an oxygen outlet, wherein the CO/CO₂ outlet is fluidly connected by a first stream to an inlet of the Boudouard reactor, and wherein the CO/CO₂ inlet is fluidly connected by a second stream to an outlet of the Boudouard reactor; and providing a CO/CO₂ tank fluidly connected to at least one of the first stream or the second stream to manufacture the carbon-oxygen battery system.

Aspect 28: The method of aspect 27, further comprising: disposing a first valve between the electrochemical cell and the CO/CO₂ tank; and disposing a second valve between the electrochemical cell and the Boudouard reactor.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A carbon-oxygen battery system, comprising:
a Boudouard reactor comprising a carbon store and in fluid communication with an electrochemical cell,
wherein the electrochemical cell comprises a CO/CO₂ inlet, a CO/CO₂ outlet, and an oxygen inlet/outlet,
wherein the CO/CO₂ outlet is fluidly connected by a first stream to an inlet of the Boudouard reactor, and
wherein the CO/CO₂ inlet is fluidly connected by a second stream to an outlet of the Boudouard reactor,
a CO/CO₂ tank fluidly configured to store CO, CO₂, or a combination thereof and connected to at least one of the first stream or the second stream; and
a fuel gauge configured to determine a state of charge based on a pressure drop through the Boudouard reactor.

2. The carbon-oxygen battery system of claim 1, wherein the pressure drop is determined between the inlet and the outlet of the Boudouard reactor.

3. The carbon-oxygen battery system of claim 1, wherein the carbon store is configured to provide carbon.

4. The carbon-oxygen battery system of claim 1, further comprising an external carbon source.

5. The carbon-oxygen battery system of claim 1, further comprising a carbon store fuel gauge configured to sense a mass of carbon in the carbon store, a volume of carbon in the carbon store, or a combination thereof.

6. The carbon-oxygen battery system of claim 1, further comprising a CO/CO₂ tank fuel gauge, wherein the CO/CO₂ tank fuel gauge is configured to sense a mass of CO/CO₂ in the CO/CO₂ tank, a pressure of CO/CO₂ in the CO/CO₂ tank, or a combination thereof.

7. The carbon-oxygen battery system of claim 1, further comprising an O₂ tank fluidly configured to store a gas comprising O₂ and connected to the electrochemical cell.

8. The carbon-oxygen battery system of claim 7, further comprising an O₂ tank fuel gauge, wherein the O₂ tank fuel gauge is configured to sense a mass of the gas comprising O₂ in the O₂ tank, a pressure of the gas comprising O₂ in the O₂ tank, or a combination thereof.

9. The carbon-oxygen battery system of claim 1, wherein the electrochemical cell comprises a positive electrode, a negative electrode, and an electrolyte, wherein the electrolyte comprises a solid oxide electrolyte, a molten carbonate electrolyte, or a combination thereof and wherein the positive electrode and the negative electrode are connected to an external circuit.

10. The carbon-oxygen battery system of claim 1, further comprising a heat exchanger configured to exchange heat between the Boudouard reactor and the electrochemical cell.

11. The carbon-oxygen battery system of claim 1, wherein at least one of the Boudouard reactor or the electrochemical cell is disposed in a thermal chamber.

12. The carbon-oxygen battery system of claim 1, wherein the electrochemical cell comprises a plurality of electrochemical cells, wherein each electrochemical cell of the plurality of electrochemical cells is in electrical contact with the external circuit.

13. The carbon-oxygen battery system of claim 12, wherein at least one electrochemical cell of the plurality of electrochemical cells is a removable electrochemical cell.

14. The carbon-oxygen battery system of claim 13, wherein the removable electrochemical cell is configured to be selectively isolated from the carbon-oxygen battery system, preferably wherein the removable electrochemical cell is configured to be selectively isolated from the carbon-oxygen battery system.

15. The carbon-oxygen battery system of claim 13, wherein each removable electrochemical cell of the plurality of removable electrochemical cells is electrically connected to the external circuit in parallel.

16. The carbon-oxygen battery system of claim 13,
wherein each removable electrochemical cell is configured to be independently isolated from the system, and
wherein the carbon-oxygen battery system is configured to operate when one or more of the removable electrochemical cells is isolated from the system and at least one electrochemical cell is not isolated from the system.

17. The carbon-oxygen battery system of claim 1, wherein the battery system comprises a plurality of electrochemical cells,
wherein the battery system further comprises a plurality of thermal chambers, and
wherein the Boudouard reactor is disposed in a first thermal chamber of the plurality of thermal chambers, and
at least one electrochemical cell of the plurality of electrochemical cells is disposed in a second thermal chamber of the plurality of thermal chambers.

18. A method of operating the carbon-oxygen battery system of claim 1, the method comprising:
supplying electricity and a CO/CO₂ stream comprising CO, CO₂, or a combination thereof to the carbon-oxygen battery system to charge the battery system, wherein
the CO/CO₂ stream is provided by the CO/CO₂ tank,
carbon dioxide from the CO/CO₂ stream is converted to carbon monoxide and oxygen by the electrochemical cell,
the carbon monoxide from the electrochemical cell is converted to carbon dioxide and carbon by the Boudouard reactor, and
the carbon produced by the charging is stored in the carbon store; and
discharging the battery system to convert the carbon to carbon dioxide and produce electricity, wherein
the carbon and carbon dioxide are converted in the Boudouard reactor to carbon monoxide,
the carbon monoxide and oxygen are converted to carbon dioxide by the electrochemical cell, the carbon dioxide is added to the CO/CO₂ stream, and
the CO/CO₂ produced by the discharging is stored in the CO/CO₂ tank.

19. The method of claim 18, further comprising determining the state of charge of the carbon-oxygen battery system using the fuel gauge, which senses the pressure drop across the Boudouard reactor.

20. The method of claim 19, wherein the determining is during the discharging of the battery system, during the charging of the battery system, or a combination thereof.

21. The method of claim 19, wherein the determining comprises determining the pressure drop between the inlet and the outlet of the Boudouard reactor.

22. The method of claim 19, further comprising accumulating the carbon dioxide in the CO/CO₂ tank.

23. The method of claim 18, wherein the CO/CO₂ stream comprises CO, CO₂, N₂, He, Ar, or a combination thereof.

24. A method of operating a carbon-oxygen battery system, the method comprising:
providing the carbon-oxygen battery system of claim 1; and
wherein the electrochemical cell is a plurality of electrochemical cells, wherein at least one electrochemical cell of the plurality is a removable electrochemical cell, and further comprising installing the removable electrochemical cell to operate the system.

25. The method of claim 24, wherein the installing occurs while charging or discharging at least one electrochemical cell of the plurality of electrochemical cells.

26. A method of operating a carbon-oxygen battery system, the method comprising:
providing the carbon-oxygen battery system of claim 13; and
isolating the removable electrochemical cell, wherein the isolating comprises closing a first valve at a position downstream of the CO/CO₂ tank and upstream of the removable electrochemical cell, closing a second valve at a position downstream of the Boudouard reactor, and disconnecting the removable electrochemical cell from the external circuit to isolate the removable electrochemical cell to operate the system.
